(19) United States
(12) Patent Application Publication
(10) Pub. No.: US 2010/0007138 A1
(43) Pub. Date: Jan. 14, 2010

(54) HOSE CONNECTOR WITH TORSIONAL DECOUPLING

(75) Inventors: Matthias Weiss, Hilchenbach (DE); Karl-Heinz Munker, Hilchenbach (DE); Dietmar Baumhoff, Olpe (DE); Oliver Selter, Lennestadt (DE); Andreas Gerhard, Wenden (DE); Karsten Schenk, Schwalmstadt (DE); Stefan Hauk, Hilchenbach (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: WESTFALIA Metallschlauchtechnik GmbH & Co. KG, Hilchenbach (DE)

(21) Appl. No.: 12/499,440

(22) Filed: Jul. 8, 2009

Related U.S. Application Data
(60) Provisional application No. 61/173,350, filed on Apr. 28, 2009.

(30) Foreign Application Priority Data
Jul. 10, 2008 (DE) 10 2008 032 427

(51) Int. Cl. F16L 51/02; B23P 11/00

(52) U.S. Cl. 285/226; 29/505

(57) ABSTRACT

A hose connector, in particular for exhaust pipes of motor vehicles includes a flexible line element, for example a metal bellows which is supported at one end face in the support member of an attachment carrier with torsional degree of freedom. A tension element is provided by which the line element can be maintained under pretension against the support member of the attachment carrier.

### CROSS-REFERENCES TO RELATED APPLICATIONS

This application claims the benefit of prior filed U.S. provisional Application No. 61/173,350, filed Apr. 28, 2009, pursuant to 35 U.S.C. 119(e), the content of which is incorporated herein by reference in its entirety as if fully set forth herein

This application also claims the priority of German Patent Application, Serial No. 10 2008 032 427, filed Jul. 10, 2008, pursuant to 35 U.S.C. 119(a)-(d), the content of which is incorporated herein by reference in its entirety as if fully set forth herein.

### BACKGROUND OF THE INVENTION

The present invention relates to a tube connector, in particular for exhaust pipes of motor vehicles, having a torsional degree of freedom. In addition, it relates to a method of connecting a line element to an attachment carrier.

The following discussion of related art is provided to assist the reader in understanding the advantages of the invention, and is not to be construed as an admission that this related art is prior art to this invention.

German patent publication DE 10 2004 034 591 A1 discloses a liquid-tight decoupling element, having a wound metal hose and a flexible tube in coaxial relationship. The flexible tube is firmly connected on one end to edging elements and on its other end torsionally and axially movably connected to edging elements. In this way, a hose connector is realized overall having high flexibility with respect to torsional and axial vibrations. Practice has shown, however, that it is difficult to design hose connectors tight enough against exhaust gas when subjected to great temperature fluctuations and resultant heat expansions.

In order to meet current demands in the field of passenger cars with respect to gas tightness, the connector ends of flexible line elements are normally welded to the adjoining exhaust pipes. A metal bellows is oftentimes a module for such line elements. As a consequence of operational movements, position of installation, and geometric disposition, the exhaust pipes of utility vehicles are increasingly twisted torsionally which must be compensated by flexible line elements. Oftentimes, multilayer wound metal hoses of profiled strip material are used as decoupling element. They are especially suitable in particular for use in exhaust systems of utility vehicles as, unlike metal bellows, they are able to decouple great torsional movements without building up structural stress. Their drawback is, however, the remaining residual leakage.

As regulations throughout the world demand in the future a significant reduction in the emission of pollutants by utility vehicles, exhaust systems are increasingly equipped with aftertreatment modules such as, e.g., particulate soot filters and SCR systems. A residual leakage which allows escape of untreated exhaust from the system is permitted only in a limited manner.

The use of a metal bellows as flexible and at the same time gastight line element is oftentimes difficult because the bellows corrugations arranged orthogonally to the rotation axis cause great stress and stress gradients in the metallic structure, in particular when subjected to torsional load, so that the service life of the line element is limited.

A solution for compensation of greater torsional movements involves the provision of two joined, helicoidally corrugated or annularly corrugated metal bellows and is described in German Pat. No. DE 198 24 095 C2. It provides the use of at least two conventional metal bellows having comparable torsional stiffness so that axial, lateral, and torsional movements are distributed to the metal bellows at comparable level. Although a greater torsional twist is thus possible, this is not realized however by a smaller torsional stiffness of the individual components but rather by doubling the path of the force flux across the entire decoupling element as a result of the coaxial bellows arrangement. The stress collective experienced during operation is still composed of axial, lateral, and torsional movements, a fact that is not optimal under the aspect of the operational reliability.

German Pat. No. DE 103 54 782 B3 discloses a further implementation of a decoupling element suitable especially for torsional movements. It includes at least two bellows-type components carrying exhaust gas which are fitted axially parallel with an axial offset or skewed with respect to the pipe axis of the adjacent line system, so that the torsional movement which need to be compensated by the bellows-like geometries can be kept to a negligible level. It is however disadvantageous that the exhaust stream must be divided.

It would therefore be desirable and advantageous to provide an improved hose connector which obviates prior art shortcomings and which exhibits sufficient flexibility to cope with vibrations that may be encountered, for example, in exhaust pipes of motor vehicles and can be configured in a gastight manner.

### SUMMARY OF THE INVENTION

According to one aspect of the present invention, a hose connector, in particular for exhaust pipes of motor vehicles, includes a flexible line element defined by an axis, an attachment carrier having a support member to bear one end of the line element with torsional degree of freedom, and a tension element applying a force to urge the line element against the support member of the attachment carrier.

The hose connector according to the invention is especially suitable for application in exhaust pipes of motor vehicles without however being limited to his particular application. The hose connector can include a combination of the following components:
A flexible line element for guiding a flow (for example of exhaust gases) with an end face and a predefined axis (the direction of the flow). The line element may be realized by a tube or a hose for example. The flexibility of the line element means that it is able to yield—within limits—to the forces normally encountered during operation through change in shape. The flexibility may especially be elastic so that encountered forces are opposed by a restoring force in correspondence to the deformation. Such elasticity may be established in particular in axial direction.
An attachment carrier with a support member for support of the afore-mentioned end face of the line element (directly or indirectly) with torsional degree of freedom. When using the hose connector, the attachment carrier can be connected especially with fixed components such as, for example, the engine block or the body of a motor vehicle. The support with “torsional degree of freedom” means that the supporting line element is able to (at least slightly) twist, i.e. rotate about its axis, in relation to the attachment carrier.
A tension element to maintain or to be able to maintain the line element under a pretension against the support member of the attachment carrier. To generate the pretension, the tension element may include a mechanical spring element for example.

A hose connector according to the present invention has the advantage that it torsionally decouples the line element and the attachment carrier through respective alternate support. This support is furthermore designed robust and reliable through the presence of a tension element which urges the line element under pretension against the support member on the attachment carrier.

The support member of the attachment carrier may basically have randomly oriented (e.g. axis-parallel) bearing surfaces for support of the end face of the line element under pretension. According to a preferred embodiment of the invention, the support member includes a bearing surface which extends substantially in orthogonal relationship to the axis of the line element for support of the end face of the line element in axial direction. In this case, there is no possibility of a relative movement between attachment carrier and line element in axial direction so that the assembly is respectively simplified.

The biasing force of the line element against the support member of the attachment carrier may especially point in axial direction. Such a direction of the pretension is especially suitable in the afore-described case in order to urge the line element against the bearing surface which extends in orthogonal relationship to the axis.

The pretension of the line element against the support member on the attachment carrier provides for a continuously closed bearing site which can thus be especially gastight. In order to design the entire hose connector in a gastight manner, also the line element may thus preferably be gastight (or “exhaust-gas-tight”, when exhaust pipes of motor vehicles are involved).

A gastight configuration of the hose connector is further assisted by providing the support member with a sealing element for support of the end face of the line element. The sealing element has to permit hereby a relative movement (with as little friction as possible) between it and the end face of the line element. When used in exhaust pipes, the sealing element must exhibit in addition the necessary resistance to temperature and chemicals. Suitable sealing elements may include in this context at least one of the following materials in any combination thereof:
Knitted and compressed elements of fibers of special steel, graphite, ceramics, or (E-, silica-, quartz-) glass fibers.
Knitted and compressed elements of fibers of special steel, graphite, ceramics, or (E-, silica-, quartz-) glass fibers and absorbent fibers on which a graphite deposit is produced through immersion in a liquid.
Precursor-coated fabric with aluminum oxide as base material.

Precursor-coated fabric with a glassy base material.
A pre-ceramic polymer of solid, pasty, or foamy consistency.
Metal coated with temperature-resistant sliding material.
Metal coated with pre-ceramic polymers.
Fiber-reinforced graphite strip.
Fiber-reinforced or metallic-lattice-reinforced graphite plates.
Temperature-resistant sliding lacquer.

Combinations of the mentioned intermediaries may also be especially suitable for particular applications.

According to another feature of the present invention, the line element may have at least one depression at an axial distance from the end face for engagement of the tension element. Such depressions are normally present in the form of constrictions in corrugated tubes used in the exhaust technology. The engagement in the depression permits a simple force application of the tension element upon the line element.

In the afore-described embodiment, the tension element may further provide a compression of the section of the line element between the depression and the end face. In the presence of an elastic section in axial direction, this compression maintains the end face under axial pretension against the support member of the attachment carrier without necessarily a need for additional structures such as springs.

In order to produce the compression of the line element section against the attachment carrier, the tension element may be supported especially axially on the attachment carrier in order to draw the components participating on the pretension directly to one another.

In order to be able to realize the compression of the line element section during assembly of the hose connector in a simple manner, the tension element includes preferably an axial degree of freedom for adjustment in relation to the attachment carrier, with this degree of freedom being fixed in the assembled state. During assembly of the hose connector, the tension element may then be brought into engagement with the depression of the line element and subsequently transferred in correspondence with the axial degree of freedom for adjustment into such an axial position in relation to the attachment carrier in which a desired pretension of the line element against the attachment carrier is established. Fixation of the degree of freedom for adjustment permanently then fixes this pretension.

The fixation of the degree of freedom for adjustment may be realized, for example, through material union (e.g. through welding of tension element and attachment carrier), in a form-fitting manner (e.g. through threaded engagement of the tension element with the attachment carrier) and/or through frictional engagement.

According to another feature of the present invention, the tension element may be supported with torsional degree of freedom upon the attachment carrier. In other words, a rotation is possible between the tension element and the attachment carrier about the axis of the line element. As the tension element has to normally act also on the line element in a force-transmitting manner, a fixed (wear-free) connection may advantageously be provided there.

According to another feature of the present invention, a sealing element may be disposed between the tension element and the attachment carrier in order to render the torsionally movable support gastight. The sealing element may hereby include the same components or materials as the afore-described sealing element between attachment carrier and line element.

As already described, the tension element normally acts on the line element in a force-transmitting manner to be able to meet its tension function. According to a particular embodiment of the invention, the tension element is hereby supported with torsional degree of freedom on the line element, i.e. rotatable in relation to the line element about its axis (within limits). The tension element may in this case remain fixed in relation to the attachment carrier.

According to another feature of the present invention, a friction-reducing layer and/or an intermediate element may be arranged between the tension element and the line element in order to enable the relative rotations as smooth as possible and without damage of the line element.

The line element may include in particular straight corrugations (i.e. closed wraparound constrictions) or helicoidal corrugations (i.e. helically revolving constrictions). Such corrugated structures of the line element provide the latter with the necessary flexibility. Furthermore, the valleys of the corrugations may serve as depressions for the engagement of the tension element.

Arranged on the end face of the line element may be an optional mount for providing a defined support of the end face in the support member of the attachment carrier. Such a mount is especially appropriate in connection with the afore-stated helicoidally corrugated line elements to provide the end face with a rotation-symmetric shape.

When the line element has helicoidally corrugated corrugations, the tension element is preferably designed in such a way that it engages these corrugations with a thread pitch in correspondence with the helix. The thread pitch of the tension element may also be formed hereby in particular by secondary form elements on a connector with inherent structural integrity. As an alternative, the thread pitch may also be implemented by adjoined secondary elements, especially in the form of metal wires and/or metal cables.

In the event the hose connector is used in exhaust pipes, it is preferred to arrange for exhaust conduction inside the line element a metal hose wound of several strip layers and/or a metal braiding. A knitted wire fabric may optionally be introduced between the metal hose and the line element to suppress bothersome contact noises.

According to another aspect of the present invention, a method of making a hose connector includes the steps of connecting a flexible line element to an attachment carrier in such a way that the line element is supported with torsional degree of freedom on the attachment carrier, and axially compressing the line element to urge the line element against the attachment carrier.

The method relates in general to the effect realized with a hose connector of the afore-described kind. Details, advantages and refinements of the method are referred to in the above description of the hose connector.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic cross section through a first hose connector according to the present invention;

FIG. 2 shows a schematic cross section through a second hose connector according to the present invention, with the end face of a helicoidally corrugated line element having a mount;

FIG. 3 shows an enlarged view of the engagement area of the tension element of FIG. 2 in a corrugation of the attached line element;

FIG. 4 shows a schematic cross section through a third hose connector according to the present invention, with the tension element being supported on the attachment carrier with torsional degree of freedom.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

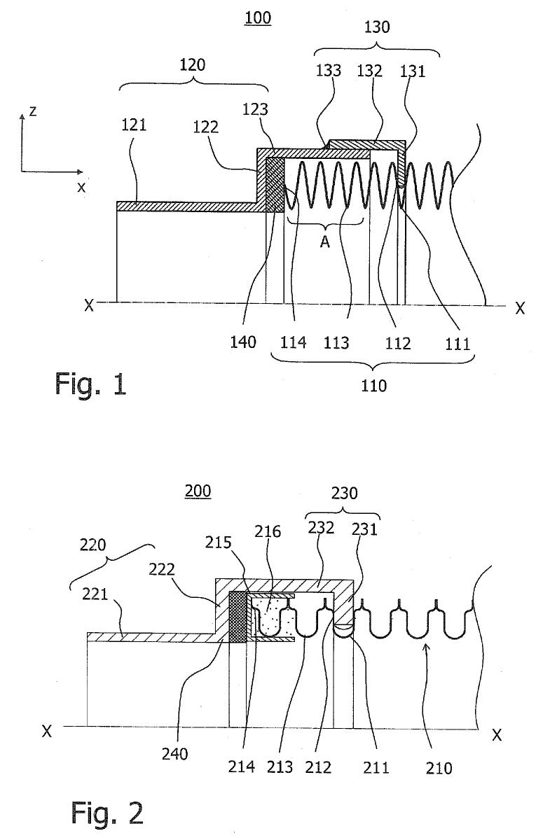

Turning now to the drawing, and in particular to FIG. 1, there is shown a first embodiment of a hose connector according to the present invention, generally designated by reference numeral 100 and constructed to meet the afore-stated objectives. The hose connector includes a combination of the following components:
1. A gastight, flexible line element 110, here in the form of a metallic tube with a bellows structure, with the corrugations 113 of the structure extending in the example of FIG. 1 in orthogonal relationship to the axis X of the line element and thus are annularly closed and have no pitch on the outer circumference. The part of the line element 110 extending to the right is not shown in the figures for sake of simplicity.
2. A torsional decoupling element with the following individual components:
2.1 An attachment carrier 120, comprised of a pipe piece 121 oriented in axis direction X and feeding toward the line element 110 into a radially extending, annular flange 122. The flange 122 forms together with a sealing element 140 a support member for the end face 114 of the line element 110. Furthermore, the attachment carrier 120 includes in succession of the radially outer edge of the flange 122 a sleeve piece 123 which surrounds the end face of the line element 110.
2.2 A tension element 130 having a L-shaped cross section and engaging with a radially extending leg 131 in a corrugation (depression) 111 of the line element 110. With its second leg 131 which extends axis-parallel, the tension element 130 rests from outside upon the sleeve piece 123.

The section A of the line element 110 positioned between the end face 114 and the engagement site 111 of the tension element 130 is compressed axially during assembly by the set axial position of the tension element 130 so as to press against the support member 122/140 under a defined pretension. The jointing site 133 permanently connects the attachment carrier 120 and the tension element 130 after establishment of the pretension. The jointing may be through friction, formfittingly or through material union and is not necessarily gastight.

A spring element may optionally also be provided, for example a torsion spring (not shown) disposed in the corrugations 113 of the line element 110 in order to sufficiently maintain the end face 114 under pretension against the attachment carrier 120. This spring element may produce the pretension by itself or contribute in addition to the compression of the section A.

An important advantage of the described combination resides in the torsional degree of freedom which follows directly the line element 110 (metal bellows) in compact construction. The corrugations disposed in the end zone A of the line element are hereby used for biasing the sealing element 140 or support member as a result of the axially adjustable tension element 130. Furthermore, the force and movements are introduced into the combination predominantly via the attachment carrier 120, the tension element 130, and the contact zone 112 in the bellows structure 110 so that the sealing element is arranged in the advantageous force bypass.

FIG. 2 shows a hose connector 200 which is constructed basically similar to the one shown in FIG. 1. The following description centers therefore primarily on the differences to the first embodiment.

The hose connector 200 includes a flexible line element 210 which includes in this case a bellows-type or membrane-bellows-type helicoidally corrugated structure with helicoidally revolving constrictions 213 having a pitch on the outer circumference.

The attachment carrier 220 of the hose connector 200 includes a sleeve-like pipe piece 221 with radially projecting flange 222 which forms together with a sealing element 240 a support member for the end face 214 of the line element 210. The tension element 230 includes a radially extending leg 231 as well as an axis-parallel leg 232 and is connected in this case in one piece with the attachment carrier 220. As a result of the helicoidally corrugated structure of the line element 210, the radial leg 213 of the tension element 230 does not extend in orthogonal relationship to the rotation axis X but obliquely. The leg 231 has hereby preferably a thread pitch which is equal to the thread pitch of the helicoidally corrugated structure of the line element 210. Alternative variations provide for a leg 231 which extends in orthogonal relationship to the rotation axis X. Under the described conditions, the line element 210 can be screwed into the tension element 230 so that different pressure biasing can be produced onto the sealing element 240 depending on the screw-in depth.

In further distinction to the first embodiment, the end face 214 of the line element 210 is received in a mount 215 to produce a smooth, gastight end which extends rotation-symmetrically and in orthogonal relationship to the rotation axis X. The mount 215 is for example constructed in the form of a circular ring shaped cup of preferably metallic materials. Embedded in the mount is the line element by means of a sealing material 216 which is resistant to high temperatures.

In the hose connectors 100, 200 shown in FIG. 1 and FIG. 2, the tension element 130 and 230, respectively is firmly connected with the attachment carrier 120 and 220, respectively. As a result, a relative rotation is realized between the tension element and the line element, when the line element 110, 210 rotates about the axis X. This causes friction of the legs 131 and 231, respectively, which engage the corrugations of the line element. To minimize this and the resultant wear, a friction-reducing layer (lubricant), a material reinforcement, a coating, or an intermediate layer, may be arranged in this area.

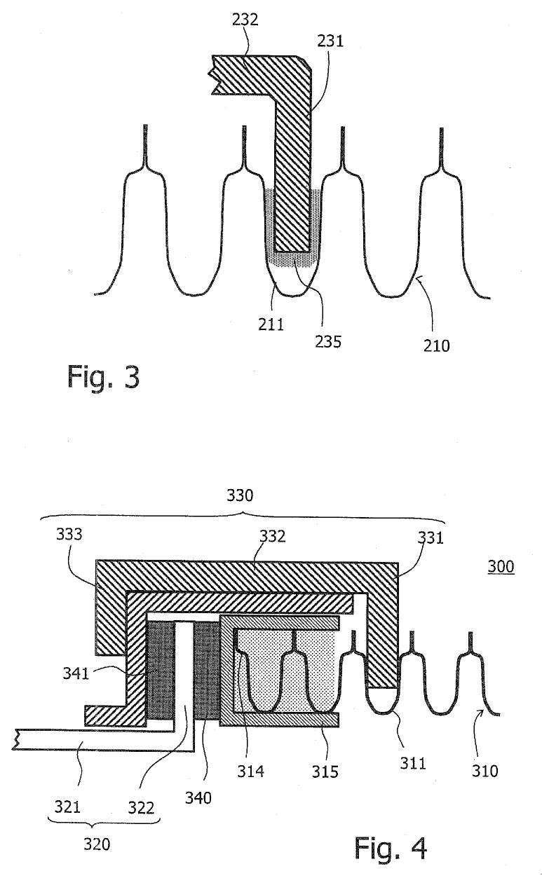

The last-mentioned option is shown schematically in FIG. 3 for the hose connector 200. An intermediate element 235 can be seen here between the radial leg 231 of the tension element and the respective winding 211 of the line element 210 for effecting a reduction of friction and wear. The intermediate element may involve, for example, a thin folded copper sheet. As an alternative, the intermediate element may also be formed by coating the leg 231, for example a coating of copper varnish or a coating which is produced through immersion of the leg in a fluxing agent or a copper filler metal.

FIG. 4 shows a third embodiment of a hose connector 300 in which the afore-described relative movements between tension element and line element are completely eliminated.

The hose connector 300 includes a line element 310 with corrugations which may be annular or helicoid (helical). Furthermore, it includes—as known—an attachment carrier 320 with a sleeve section 321 and a radial flange 322 which together with a sealing element 340 forms the support member for the end face 314 of the line element 310. Like in FIG. 2, the end face 314 is hereby received in a mount 315.

The tension element 330 includes a radially extending leg 331 which engages a constriction 311 of the line element 310 to urge it under pretension against the support member 322, 340. As a difference to the preceding embodiments, the tension element 330 is however not firmly connected with the attachment carrier 320 but is movably supported for rotation relative thereto. For this purpose, the tension element 330 is provided at the end of its axis-parallel leg 332 with a second radially extending flange 333 which is supported axially on a sealing element 341 that is supported on the outer side of the leg 322 of the attachment carrier 320. As the line element 310 rotates about its axis X, it moves the tension element 330 with it because the latter is able to slide on the sealing element 341. In this way, wear of the line element 310 at the engagement site 311 of the tension element is minimized.

The tension elements 130, 230, 330 illustrated in the embodiments may be constructed basically closed annularly about the hose connector by 360°.

According to a preferred embodiment of the invention, the tension element is composed however of several (identical or different) single parts which respectively extend only over a limited angle sector about the axis X. At least two, preferably three or more of such single parts, may be distributed symmetrically about the circumference of the hose connector. As shown in FIG. 4, the single parts may be configured for example in the form of U-shaped clamps 330, preferably curved in tangential relationship to the rotation axis, to facilitate the assembly of the hose connector.

The described hose connectors may be modified or refined in many ways. For example, they may include inside for exhaust guidance a metal tube wound of several strip layers (not shown). The metal tube assumes furthermore damping tasks and enhances the acoustic and thermal insulation properties of the componentry.

In summary, the invention relates in its preferred embodiment to a hose connector or combination of exhaust-gas-tight, flexible line element and torsional decoupling element, wherein:
a flexible bellows structure with straight or helicoidally corrugated corrugations is pressed under pretension in the end zone against a sealing element in such a manner that the sealing element is arranged with respect to the operating movements substantially in the force bypass and a torsional degree of freedom is retained in the hose connector;
and/or the bellows structure has corrugations which individually extend in orthogonal relationship to the rotation axis;
and/or the bellows structure has corrugations which have a pitch on the outer circumference and are interconnected;
and/or a defined biasing force upon a sealing element is adjusted by an axial degree of freedom for adjustment in the connector technology;
and/or the axial fixation in the connector technology is realized by material union;
and/or the axial fixation in the connector technology is realized in a formfitting manner;
and/or the axial fixation in the connector technology is realized by frictional engagement;
and/or connector technology and bellows-type structure have in the contact zone same thread pitches;
and/or the thread pitch in the connector technology is established by secondary form elements at one connection with inherent structural integrity;
and/or the thread pitch in the connector technology is realized by adjoined secondary elements;
and/or the adjoined secondary elements are metal wires;
and/or the adjoined secondary elements are metal cables;
and/or a metal tube wound of several strip layers is arranged inside for exhaust guidance;
and/or a metal braiding is arranged inside for exhaust guidance;
and/or a knitted wire fabric is placed between metal tube and hose connector;
and/or the sealing element is a compressed knitted metal fabric with fibers of graphite, ceramics, or (E-, silica-, quartz-) glass fibers;
and/or the sealing element is a compressed knitted metal fabric with additional absorbent fibers on which a graphite deposit is produced through immersion in a liquid;
and/or the sealing element is a precursor-coated fabric with aluminum oxide as base material;
and/or the sealing element is a precursor-coated fabric with glassy base material;
and/or the sealing element is a pre-ceramic polymer of solid, pasty, or foamy consistency;
and/or the sealing element is a metal coated with temperature-resistant sliding material;
and/or the sealing element is a metal coated with pre-ceramic polymers;
and/or the sealing element is a fiber-reinforced graphite strip;
and/or the sealing element is made of fiber-reinforced or metallic-lattice-reinforced graphite plates;
and/or the sealing element is made of a knitted metal fabric compressed with a graphite paste;
and/or the sealing element is a metal sheet coated with temperature-resistant sliding lacquer;
and/or the metallic support surfaces of the sealing element are provided with annularly revolving embossments or elevations to enhance the surface pressure in local sealing zones.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A hose connector, in particular for exhaust pipes of motor vehicles, comprising:
a flexible line element defined by an axis;
an attachment carrier having a support member to bear one end face of the line element with torsional degree of freedom; and
a tension element applying a force to urge the line element against the support member of the attachment carrier.

2. The hose connector of claim 1, wherein the support member has a bearing surface extending substantially in an orthogonal relationship to the axis.

3. The hose connector of claim 1, wherein the tension element is constructed to direct the force in a direction of the axis.

4. The hose connector of claim 1, wherein the line element is constructed to be exhaust-gas-tight.

5. The hose connector of claim 1, wherein the attachment carrier includes at least one sealing element for support of the end face of the line element.

6. The hose connector of claim 5, wherein the sealing element includes at least one element selected from the group consisting of knitted and compressed elements of fibers of special steel, graphite, ceramics, or (E-, silica-, quartz-) glass fibers, absorbent fibers on which a graphite deposit is produced through immersion in a liquid, precursor-coated fabric with a base material which is aluminum oxide or glassy, a pre-ceramic polymer of solid, pasty, or foamy consistency, a metal coated with temperature-resistant sliding material, a metal coated with pre-ceramic polymers, a fiber-reinforced graphite strip, fiber-reinforced or metallic-lattice-reinforced graphite plates, and a temperature-resistant sliding lacquer.

7. The hose connector of claim 1, wherein the tension element is constructed to engage the line element in a depression thereof positioned at an axial distance to the end face.

8. The hose connector of claim 7, wherein the tension element interacts with the line element to compress a section of the line element between the depression and the end face.

9. The hose connector of claim 1, wherein the tension element has an axial portion supported axially on the attachment carrier.

10. The hose connector of claim 1, wherein the tension element is constructed to have in relation to the attachment carrier an axial degree of freedom for adjustment which is fixed in an assembled state.

11. The hose connector of claim 10, wherein the tension element is connected in the fixed assembled state to the attachment carrier by at least one process selected from the group consisting of material union, formfitting engagement, and frictional engagement.

12. The hose connector of claim 1, wherein the tension element is supported on the attachment carrier with torsional degree of freedom.

13. The hose connector of claim 1, further comprising a sealing element arranged between the tension element and the attachment carrier.

14. The hose connector of claim 1, wherein the tension element is supported on the line element with torsional degree of freedom.

15. The hose connector of claim 1, further comprising a friction-reducing layer and/or an intermediate layer arranged between the tension element and the line element.

16. The hose connector of claim 1, wherein the line element has straight or helicoidally corrugated corrugations.

17. The hose connector of claim 1, further comprising a mount arranged on the end face of the line element.

18. The hose connector of claim 1, wherein the line element has helicoidally corrugated corrugations for engagement by the tension element with corresponding thread pitch.

19. The hose connector of claim 18, further comprising secondary form elements or adjoined secondary elements to form the thread pitch of the tension element.

20. The hose connector of claim 19, wherein the secondary form elements or adjoined secondary elements include metal wires and/or metal cables.

21. The hose connector of claim 1, wherein the tension element is comprised of several substantially identical single parts.

22. The hose connector of claim 1, wherein the tension element includes at least one U-shaped clamp.

23. The hose connector of claim 22, wherein the clamp is curved tangentially in relation to a rotation axis.

24. The hose connector of claim 1, further comprising a metal tube wound of several strip layers arranged inside the hose connector.

25. The hose connector of claim 1, further comprising a metal braiding arranged inside the hose connector.

26. The hose connector of claim 24, further comprising a knitted wire fabric arranged between the metal tube and the line element.

27. The hose connector of claim 1, wherein the attachment carrier and the tension element jointly form a torsional decoupling element, with the line element defining a flexible bellows structure with straight or helicoidally corrugated corrugations and biased in an end zone against a sealing element in such a manner that the sealing element is arranged with respect to operating movements substantially in a force bypass and in assembled state retains a torsional degree of freedom.

28. A method of making a hose connector, comprising the steps of:
connecting a flexible line element to an attachment carrier in such a way that the line element is supported with torsional degree of freedom on the attachment carrier; and
axially compressing the line element to urge the line element against the attachment carrier.
